(19) United States
(12) Patent Application Publication
(10) Pub. No.: US 2026/0259968 A1
(43) Pub. Date: Sep. 3, 2026

(54) VISUAL BIOMETRIC RECOGNITION METHOD FOR SECURITY AND AUTOMATED PAYMENT

(71) Applicant: Moment.AI Technologies Inc., Arlington, VA (US)

(72) Inventors: Megan Gray, Arlington, VA (US); Matthew Tarascio, Westport, CT (US)

(21) Appl. No.: 19/369,991

(22) Filed: Oct. 27, 2025

Related U.S. Application Data
(60) Provisional application No. 63/711,903, filed on Oct. 25, 2024.

(51) Int. Cl. G06F 21/32; G06V 10/75; G06V 10/774; G06V 40/16; G06V 40/50

(52) U.S. Cl. CPC G06F 21/32; G06V 10/751; G06V 10/774; G06V 40/168; G06V 40/172; G06V 40/50

(57) ABSTRACT

A method for identifying a user based on facial recognition and synthetic facial data, the method including: a) executing visual biometric recognition training which generates a plurality of synthetic data samples; b) executing one or more biometric learning models on the synthetic data samples to create one or more biometric identification models; c) registering one or more users into a biometric recognition and associating biometric data of a user with biometric data from the synthetic data samples; d) creating a unique identifier associated with each user based on the biometric data and the synthetic data; e) identifying the user based on extracting one or more biometrics from the images of the user and matching the biometrics with the unique identifier. The method may include automatic payment after the identifying based on one or more payment methods associated with the unique identifier.

### CROSS REFERENCE TO RELATED APPLICATIONS

This application claims priority from U.S. Provisional Application No. 63/711,903, filed on Oct. 25, 2024; and which is incorporated herein by reference in their entirety for all purposes.

### FIELD

The present teachings relate to a visual recognition method using facial biometric data. The present teachings may find use in automating payment using facial biometric data. The present teachings relate to a method of augmenting sample data used in artificial intelligence models. The present teachings may be useful in avoiding the need for prior documentation in conjunction with visual recognition.

### BACKGROUND

Typically, one-on-one mapping is needed for utilizing facial recognition is different security settings. One-on-one mapping typically requires prior documentation and/or prior knowledge device authorization. Prior documentation may include a government issued identification, such as a passport or driver's license. A prior knowledge device may include a smart phone. With one-on-one mapping, individual biometrics are collected and then matched with the prior documentation and/or prior knowledge device authorization. While this type of one-on-one mapping is known to achieve an accuracy of 90% or greater, it is unable to be used where there is no prior documentation and/or prior knowledge device authorization. Examples of such one-on-one mapping include CLEAR which requires a person to insert their identification or scan their passport, along with facial recognition, to go through Transportation Security Administration (TSA).

Facial recognition that uses a person's biometrics instead of extraction has led to artificial intelligence (AI) bias. This AI bias has resulted in lessened use in security or police environments due to error rates being 34% or higher for darker skinned individuals. See https://sitn.hms.harvard.edu/flash/2020/racial-discrimination-in-face-recognition-technology/, which is incorporated herein by reference in its entirety.

Today, there are some virtual payment methods which use facial recognition. Facial recognition for payments such as “tap” involves a one-to-one mapping. In these instances, there is a facial recognition algorithm trained to recognize a single specific face associated with a particular camera, sensor, and/or other specific device.

While these methods may be useful, retail environments require recognizing millions of faces across numerous machines. Recent advancements, like Amazon's “Amazon One”, use palm vein recognition to facilitate payments, indicating a shift toward more diverse biometric methods. Additionally, enterprises, such as Netflix, which require a subscription based on the number of users struggle with user authorization in remote locations, such as homes.

### SUMMARY

Analyzing face and body biometrics using a large vision model that uses synthetic data images and videos to pre-train models and enhance accuracy. The system uses synthetic biometric data generated by the GAN model. The system creates a facial signature/unique ID based on numerical vector representation of data points of each person-labeling people based on extractions matching synthetic biometrics. This method uses machine learning and deep learning to pre-train models and neural networks with millions of images and videos of artificial faces and bodies. This Unique ID synthetic biometric can be used for identification, virtual/digital payment, security screening, personalized shopping experiences, user authorization.

This system uses a numerical time-series of generated faces to identify individuals for payment processing. Millions of faces are generated through the GAN biometric, creating a “face factory” of synthetic biometric data to pre-train models using machine learning and deep learning techniques to recognize hundreds of biometric markers within a person's face-while also using AI to annotate for object detection such as glasses, eye patches, scars, wrinkles, etc.

Unlike one-to-one systems, this numerical model generates a Unique ID—a series of numbers and letters—upon initial use. The subject moves their head and face in front of a designated camera, where their facial biometrics are extracted and matched to synthetic data, and the Unique ID is linked to their payment method. Due to lighting conditions, it will most likely need to be in a convenient designated location: retail store, bank, post office. This Unique ID can be recognized across different locations without requiring a phone or physical card. In essence, due to the GAN model being used, a biometric mathematical representation of the person is being matched to pre-train synthetic models.

A multi-model can be used in instances where behavior such as a person's gait, health or other behavior can be added as a layer to the Unique ID.

This method ensures payer privacy, and enables verification, potentially reducing theft upon entrance to a store if a payment method is not tagged to that unique ID.

### BRIEF DESCRIPTION OF DRAWINGS

FIG. 1 illustrates a flow chart of the visual biometric recognition system.

FIGS. 2A and 2B illustrate using a facial recognition device.

FIGS. 3A, 3B, and 3C illustrate using a facial recognition device at a retail setting checkout counter.

FIG. 4 illustrates using a facial recognition device at a retail setting at the entrance and exit.

### DETAILED DESCRIPTION

The explanations and illustrations presented herein are intended to acquaint others skilled in the art with the present teachings, its principles, and its practical application. The specific embodiments of the present teachings as set forth are not intended as being exhaustive or limiting of the present teachings. The scope of the present teachings should be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

### Setting(s) for Visual Biometric System and Method

The visual biometric recognition system and method may be found useful in multiple settings. The settings may be settings in which security and identification of individuals is desired. The settings may be settings in which automatic payment from a user would be beneficial. The settings may include one or more security settings (e.g., security entrances), commercial retail settings (e.g., grocery store, apparel store, technology store), travel settings (e.g., airports, train stations), entertainment settings (e.g., auditorium, theatre), sports settings (e.g., stadium), the like, or a combination thereof.

The system and method may be advantageous for identifying individuals in security settings and/or commercial retail settings. For example, identifying one or more humans without the need for a prior documentation or a prior knowledge device.

The system and method may be advantageous for identifying an individual and automatically executing payment. For example, automatically executing payment from an individual at a store based on facial recognition.

Other settings may be those as disclosed in PCT Application No. PCT/US2024/032781, as filed on Jun. 6, 2024, which is incorporated herein by reference in its entirety.

### Recognition Device

The present teachings may relate to a recognition device. The recognition device may be useful in recognizing and monitoring one or more users, such as in one or more settings. The recognition device may be useful for locating within one or more settings. The recognition device may be integrated into one or more settings. The recognition device may be temporarily, semi-permanently, and/or permanently affixed and/or located within a setting. As exemplary configurations, a recognition device may be located (e.g., positioned, affixed) at or near an exit, entrance, security gate, counter, checkout desk, surrounding walls, the like, or any combination thereof. The recognition device may include one or more sensing devices (e.g., cameras), sensing device connections, sensing device modules, image processing units, processors, memory storage devices, housings, applications, network connections, power supplies, the like, or any combination thereof.

The recognition device may include one or more viewer sensing devices. The one or more sensing devices may function to detect the presence of a user, recognize a user, monitor a user, the like, receive and/or transmit data related to the user, or any combination thereof. The one or more sensing devices may include one or more cameras, motion sensors, heart rate monitors, breathing monitors, the like, or any combination thereof.

One or more sensing devices may include one or more cameras (e.g., camera modules). The one or more cameras may be suitable for capturing one or more videos, images, frames, the like, or any combination thereof. The one or more cameras may be positioned within a setting to have a line of sight on one or more users. Line of sight may mean the camera is in view of at least part of or all of a person's face, at least part of or all of a person's body (e.g., upper torso, arms, shoulders, legs, etc.), or any combination thereof. Line of sight may mean having the user's eyes, nose, mouth, ears, neck, or any combination thereof in view of the camera. The one or more cameras may have a line of sight (e.g., have in view) a single user or a plurality of users. The recognition device may be free of one or more sensing devices and/or be in communication with one or more sensing devices. The one or more cameras may have a wide-angle lens (e.g., viewing angle of 150 degrees or greater). The one or more cameras may be capable of capturing static images, video recordings, or both at resolutions of about 480 pixels or greater, 640 pixels or greater, 720 pixels or greater, or even 1080 pixels or greater. The one or more cameras may be able to capture video recordings at a frame rate of about 25 frames per second or greater, about 30 frames per second or greater, about 60 frames per second or greater, or even 90 frames per second or greater. A suitable camera for use with the recognition device may include the SainSmart IMX219 Camera Module with an 8MP sensor and 160-degree field of vision, the camera module and its specifications incorporated herein by reference for all purposes.

The recognition device may include or be connectable with one or more sensing device connections. The one or more sensing device connections may function to connect one or more sensing devices to the recognition device, an image processing unit, a power supply, the like, or any combination thereof. The one or more sensing device connections may be wired, wireless, or both. The one or more sensing device connections may include one or more communication wires connecting one or more sensing devices to one or more image processing units. For example, the one or more sensing device connections may include a wire connecting a camera (e.g., camera module) to an image processing unit. The one or more sensing device connections may be any type of cable and or wire suitable for transferring data including video, images, frames, sound, the like, or any combination thereof. The one or more sensing device connections may allow for one or more sensing devices to be located within a same housing as an image processing unit.

The recognition device may include one or more image processing units. One or more image processing units may function to receive, process, transmit image data, or any combination thereof; store image data; or both. The one or more image processing units may include one or more processors, memory storage devices, circuit boards, the like, or any combination thereof. The one or more image processing units may include one or more central processing units, graphics processing units, memory mediums, storage mediums, the like, or any combination thereof. The one or more image processing units may include an electronic circuit board or similar. The electronic circuit board may house and place one or more processing units and memory storage devices in communication with one another. The electronic circuit board may be in communication with one or more sensing device modules, power supply sources, network connections, the like, or any combination thereof. The electronic circuit board may be located within a housing of a recognition device. The electronic circuit board may be housed in a same or different housing as one or more sensing devices.

The one or more image processing units may include one or more processors. One or more processors may function to analyze image data, execute instructions, transmit image data, or any combination thereof. The one or more processors may be located within the recognition device. The one or more processors may be located within a same or separate housing as one or more sensing devices. The one or more processors may include a single or a plurality of processors. The one or more processors may function to process data, execute one or more instructions to analyze data, or both. Processing data may include receiving, transforming, outputting, executing, the like, or any combination thereof. One or more processors may be in communication with one or more memory storage devices. One or more processors may access and execute one or more instructions stored within one or more memory mediums. One or more processors may store processed data within one or more storage mediums. One or more processors may be part of one or more hardware, software, systems, or any combination thereof. The one or more processors may be referred to as one or more electronic processors. One or more hardware processors may include one or more central processing units, multi-core processors, front-end processors, graphics processors, the like, or any combination thereof. One or more processors may include one or more central processing units (CPU), graphics processing units (GPU), or both. One or more processors may be in communication with, work together with, or both one or more other processors. For example, a central processing unit may cooperate with a graphics processing unit. One or more processors may be a processor, microprocessor, electronic circuit, the like, or a combination thereof. For example, a central processing unit may be a processor or microprocessor. A central processing unit may function to execute instructions stored within a memory medium of the recognition device. An exemplary central processing unit may include the Cortex-A57 processor provided by Arm Limited, the processor and its specifications incorporated herein by reference for all purposes. As an example, a graphics processing unit may include one or more electronic circuits. A graphics processing unit may function to accelerate creation and rendering of image data. Image data may include images, videos, animation, frames, the like, or a combination thereof. The graphics processing unit may be beneficial in performing fast math calculations associated with the image data and freeing up processing capacity of the central processing unit. An exemplary graphics processing unit may include the GeForce® GTX 1650 D6 0C Low Profile 4G (model number GV-N1656OC-4GL) by GIGA-BYTE Technology Co., the module and its specifications incorporated herein by reference. The one or more processors may be non-transient. The one or more processors may convert incoming data to data entries to be saved within one or more storage mediums.

One or more image processing units may include one or more memory storage devices (e.g., electronic memory storage device). The one or more memory storage devices may function to store data, databases, instructions, or any combination thereof. The one or more memory storage devices may include one or more hard drives (e.g., hard drive memory), chips (e.g., Random Access Memory “RAM)”), discs, flash drives, memory cards, the like, or any combination thereof. One or more discs may include one or more floppy diskettes, hard disk drives, optical data storage media including CD ROMs, DVDs, and the like. One or more chips may include ROMs, flash RAM, EPROMs, hardwired or preprogrammed chips, nanotechnology memory, or the like. The data stored within one or more memory storage devices may be compressed, encrypted, or both. The one or more memory storage devices may be located within a recognition device. One or more memory storage devices may be non-transient. One or more memory storage devices may include one or more memory mediums, storage mediums, the like, or a combination thereof. One or more memory mediums may store one or more computer executable instructions. One or more memory mediums may store one or more algorithms, methods, rules, the like, or any combination thereof. One or more memory mediums may be accessible by one or more processors (e.g., CPU, GPU) to read and/or execute one or more computer executable instructions. An exemplary memory medium may include the Kingston ValueRAM 4GB DDR SDRAM Memory Module, the memory module and its specifications incorporated herein by reference. One or more storage mediums may store one or more databases. One or more storage mediums may store one or more algorithms, methods, rules, the like, or a combination thereof. One or more storage mediums may store one or more computer executable instructions. Instructions, algorithms, methods, rules, and the like may be transferred from one or more storage mediums to one or more memory mediums for accessing and execution by one or more processors. One or more storage mediums may store one or more data entries in a native format, foreign format, or both. One or more storage mediums may store data entries as objects, files, blocks, or a combination thereof. One or more storage mediums may store data in the form of one or more databases. One or more storage mediums may store data received from one or more processors (e.g., CPU, GPU). One or more storage mediums may store data received from one or more processors after the one or more processors execute one or more instructions from one or more memory mediums. An exemplary storage medium may include the 16 GN eMMC Module XU4 Linux sold by HardKernel Co., Ltd., the module and its specifications incorporated herein by reference.

The recognition device may include one or more power supplies. A power supply may function to provide electric power to an electrical load of a recognition device, transmit power to an image processing unit, or both. A power supply may be any device capable of converting electric current from a power source to a correct voltage, current, and/or frequency to power the electrical load of the recognition device. A power supply may be located in the same or a different housing as an image processing unit. A power supply may have one or more power input connections, power output connections, or both. A power input connection may function to connect to a power input, receive energy in the form of electric current from a power source, or both. A power source may include an electrical outlet, energy storage devices, or other power supplies. A power output connection may function to connect to one or more electric components of a recognition device, connect to an image processing unit, delivery current to one or more electrical loads of the recognition device, or any combination thereof. The power input connection, power output connection, or both may be wired (e.g., hardwired circuit connection) or wireless (e.g., wireless energy transfer). An exemplary power supply may be the RS-15-24 single output switching power supply by MEAN WELL which is an AC/DC 15 24V single output power supply, the power supply and its specifications incorporated herein by reference.

The recognition device may include one or more network connections. The one or more network connections may function to place the recognition device in communication with one or more networks. The one or more network connections may be in communication with and/or connected to one or more image processing units. The one or more network connections may be in communication with one or more networks. The one or more network connections may be suitable for connecting to the Internet. The one or more network connections may include one or more IoT (i.e., “Internet of Things) connections. The one or more network connections may be wired, wireless, or both. An exemplary network connection may include the INP 1010/1011 multi-protocol wireless module provided by InnoPhase, the module and its specifications incorporated herein by reference.

The recognition device may include one or more application layers. The one or more application layers may function to retain one or more facial recognition and monitoring methods, provide accessible computer executable instructions, be accessible by one or more image processing units, the like, or any combination thereof. The one or more application layers may be software (e.g., computer executive instructions). The one or more application layers may be in communication with one or more networks. The one or more application layers may be able to be created, updated, or otherwise modified remotely via one or more networks and one or more network connections.

The recognition device may be part of a visual biometric recognition system. The visual biometric recognition training system may also serve as a visual biometric recognition system, thus useful for both during, after, and continuous training.

The present teachings incorporate a recognition device, such as from PCT Application No. PCT/US2024/032781, filed on Jun. 6, 2024, incorporated herein by reference in its entirety.

### Visual Biometric Recognition System

The VBR System (also referred to as “system”) may include one or more physical data centers. A physical data center may function to house one or more components of the VBR System. The physical data center may function to host one or more servers, processors, memory storage devices, networks, the like, or any combination thereof. The physical data center may function to provide a non-transient host location for one or more components of the VBR System. The physical data center may include at about 1 terabyte of storage space or greater, about 2 terabytes of storage space or greater, or even 5 terabytes of storage space or greater. The physical data center may operate one or more components on one or more operating systems. One or more operating systems may include Linux, Windows, MacOS, ArcaOS, Haiku, ReactOS, FreeDOS, Wayne OS, the like, or any combination thereof. The physical data center may function to host one or more modules, execute one or more modules, or both of a cloud-based network.

The system may include one or more processors. The one or more processors may function to analyze one or more data from one or more sensing devices, memory storage devices, databases, user interfaces, recognition devices, modules, the like or any combination thereof; convert one or more incoming data signals to data suitable for analysis and/or saving within a database (e.g., data conversion, data cleaning); or a combination thereof. One or more processors may be included in one or more user interfaces, servers, computing devices, the like, or any combination thereof. The one or more processors may or may not be cloud-based (e.g., remote from other portions of the system). One or more processors hosted by a physical data center may be considered cloud-based. One or more processors hosted remotely from one or more recognition devices, personal computing devices, or both may be considered cloud-based. One or more processors may include a single or a plurality of processors. One or more processors may be in communication with one or more other processors. One or more processors may be associated with and/or execute one or more modules of one or more systems. The one or more processors may function to process data, execute one or more algorithms to analyze data, or both. Processing data may include receiving, transforming, outputting, executing, the like, or any combination thereof. One or more processors may be part of one or more hardware, software, systems, or any combination thereof. One or more hardware processors may include one or more central processing units, multi-core processors, front-end processors, graphics processing units, the like, or any combination thereof. The one or more processors may be non-transient. The one or more processors may be referred to as one or more electronic processors. The one or more processors may convert data signals to data entries to be saved within one or more memory storage devices. The one or more processors may access one or more algorithms (e.g., computer executable instructions) saved within one or more memory storage mediums.

The system may include one or more memory storage devices (e.g., electronic memory storage device). The one or more memory storage devices may store data, databases, algorithms, processes, methods, or any combination thereof. The one or more memory storage devices may include one or more hard drives (e.g., hard drive memory), chips (e.g., Random Access Memory “RAM”), discs, flash drives, memory cards, the like, or any combination thereof. One or more discs may include one or more floppy diskettes, hard disk drives, optical data storage media including CD ROMs, DVDs, and the like. One or more chips may include ROMs, flash RAM, EPROMs, hardwired or preprogrammed chips, nanotechnology memory, or the like. The one or more memory storage devices may include one or more cloud-based storage devices. One or more memory storage devices located remote from one or more recognition devices, personal computing devices, and/or user interfaces, may be considered a cloud-based storage device. The data stored within one or more memory storage devices may be compressed, encrypted, or both. The one or more memory storage devices may be located within one or more computing devices, servers, processors, user interfaces, or any combination thereof. One or more memory storage devices may be referred to as one or more electronic memory storage devices. One or more memory storage devices may be non-transient. One or more memory storage mediums may store one or more data entries in a native format, foreign format, or both. One or more memory storage mediums may store data entries as objects, files, blocks, or a combination thereof. The one or more memory storage mediums may include one or more algorithms, methods, rules, databases, data entries, the like, or any combination thereof stored therein. The one or more memory storage mediums may store data in the form of one or more databases.

One or more computing devices may include one or more databases. The one or more databases may function to receive, store, and/or allow for retrieval of one or more data entries. Data entries may be one or more video streams, frames, identifiers, frame analysis results, user data, purchasing history, and the like associated with one or more users. The one or more databases may be located within one or more memory storage devices. The one or more databases may include any type of database able to store digital information. The digital information may be stored within one or more databases in any suitable form using any suitable database management system (DBMS). Exemplary storage forms include relational databases (e.g., SQL database, row-oriented, column-oriented), non-relational databases (e.g., NoSQL database), correlation databases, ordered/unordered flat files, structured files, the like, or any combination thereof. The one or more databases may store one or more classifications of data models. The one or more classifications may include column (e.g., wide column), document, key-value (e.g., key-value cache, key-value store), object, graph, multi-model, or any combination thereof. One or more databases may be located within or be part of hardware, software, or both. One or more databases may be stored on a same or different hardware and/or software as one or more other databases. One or more databases may be located in a same or different non-transient storage medium as one or more other databases. The one or more databases may be accessible by one or more processors to retrieve data entries for analysis via one or more algorithms, methods, rules, processes, or any combination thereof. The one or more databases may include a single database or a plurality of databases. One database may be in communication with one or more other databases. One or more other databases may be part of or separate from the system. One or more databases may be connected to one or more other databases via one or more networks. Connection may be wired, wireless, the like, or a combination thereof. For example, a database of the system may be in communication with one or more other databases via the Internet. The database may also receive one or more outputs of the system. The database may be able to have the data outputted, sorted, filtered, analyzed, the like, or any combination thereof. The database may be suitable for storing a plurality of records.

The system may include one or more applications. The application (i.e., “computer program”) may function to access data, upload data, or both to the VBR System, interact with a user interface, or any combination thereof. The application may be stored on one or more memory storage devices. The application may be stored on one or more personal computing devices. The application may comprise and/or access one or more computer-executable instructions, algorithms, rules, processes, methods, user interfaces, menus, databases, the like, or any combination thereof. The computer-executable instructions, when executed by a computing device may cause the computing device to perform one or more methods described herein. The application may be downloaded, accessible without downloading, or both. The application may be downloadable onto one or more computing devices. The application may be downloadable from an application store (i.e., “app store”). An application store may include, but is not limited to, Apple App Store, Google Play, Amazon Appstore, or any combination thereof. The applicable may be accessible without downloading onto one or more computing devices. The application may be accessible via one or more web browsers. The application may be accessible as a website. The application may interact and/or communication through one or more user interfaces. The application may be utilized by one or more computing devices. The application may be utilized on one or more computing devices. The application may also be referred to as a dedicated application.

One or more computing devices (e.g., personal computing devices) may include one or more user interfaces. The one or more user interfaces may function to display information related to a user, receive user inputs related to a user, display data and/or one or more prompts to a user, or any combination thereof. The one or more user interfaces may be suitable for receiving data from a user. The one or more user interfaces may include one or more graphic user interfaces (GUI), audio interfaces, image interfaces, the like, or any combination thereof. One or more graphic user interfaces may function to display visual data to a user, receive one or more inputs from the user, or both. The one or more graphic interfaces may include one or more screens. The one or more screens may be a screen located on a computing device. The one or more screens may be a screen on a mobile computing device, non-mobile computing device, or both. The one or more graphic interfaces may include and/or be in communication with one or more user input devices, audio interfaces, image interfaces, the like, or any combination thereof. The one or more user input devices may allow for receiving one or more inputs from a user. The one or more input devices may include one or more buttons, wheels, keyboards, switches, mice, joysticks, touch pads (i.e., a touch-sensitive area, provided as a separate peripheral or integrated into a computing device, that does not display visual output), touch-sensitive monitor screens, microphones, the like, or any combination thereof. The one or more input devices may be integrated with a graphic user interface. An audio interface may function to project sound to a user and/or receive sound from a user. The audio interface may include audio circuitry, one or more speakers, one or more microphones, the like, or any combination thereof. An image interface may function to capture, receive, display, and/or transmit one or more images. An image interface may include one or more cameras. A user interface may function to display and/or navigate through one or more menus of the application.

The system may include one or more computing devices. The one or more computing devices may function to allow a user to interact with an application, the system, or both; execute one or more algorithms, methods, and/or processes; receive and/or transmit one or more signals, convert one or more signals to data entries, retrieve one or more data entries from one or more storage mediums, or any combination thereof. The one or more computing devices may include and/or be in communication with one or more processors, memory storage devices, servers, networks, user interfaces, recognition devices, other computing devices, the like, or any combination thereof. The one or more or more computing devices may be in communication via one or more interaction interfaces (e.g., an application programming interface (“API”)). The computing device may be one or more personal computers (e.g., laptop or desktop), mobile devices (e.g., mobile phone, tablet, smart watch, etc.), or any combination thereof. The computing device may include one or more personal computing devices. Personal computing devices may be computing devices typically used by a single person, having a log-in or sign-in function or other user authentication, can store and relay information privately to a user, the like, or a combination thereof. Personal computing devices may have the ability to transmit one or more notifications to one or more emergency services, predetermined contacts, the like, or a combination thereof. Personal computing devices may have the ability to send and/or receive one or more text messages, SMS messages, push notifications, emails, phone calls, the like, or any combination thereof.

The system of the present disclosure may be integrated and/or include one or more networks. The physical data center, one or more user interfaces, one or more personal computing devices, one or more recognition devices, one or more cloud networks, or any combination thereof may be in selective communication with one or more networks. The one or more networks may be formed by placing two or more computing devices in communication with one another. One or more networks may include one or more physical data centers, communication hubs, communication modules, computing devices, processors, databases, servers, memory storage devices, recognition devices, sensing devices, the like, or any combination thereof. One or more networks may be free of and/or include one or more communication hubs (e.g., router, wireless router). One or more components of the system may be directly connected to one another without the use of a communication hub. One or more networks may be connected to one or more other networks. One or more networks may include one or more local area networks (“LAN”), wide area networks (“WAN”), virtual private network (“VPN”), intranet, Internet, cellular networks, the like, or any combination thereof. The network may be temporarily, semi-permanently, or permanently connected to one or more computing devices, recognition devices, user interfaces, the like, or any combination thereof. A network may allow for one or more computing devices, recognition devices, user interfaces, physical data centers, or a combination thereof to be connected to one or more portions of the system, transmit data between one or more components of the system, or any combination thereof. One or more portions of the network hosted at one or more physical data centers may form one or more cloud-based network, recognition device management networks, video stream management network, the like, or any combination thereof.

The system may include one or more recognition device management networks. The one or more recognition device management networks may function to receive and collect data from one or more recognition devices. The one or more recognition device management networks may be at least partially hosted by the same or different physical data centers as the cloud-based network, video stream management network, or both. The one or more recognition device management networks may include one or more remote storage devices, recognition devices, processors, or a combination thereof. The one or more remote storage devices may include one or more main storage devices, node storage devices, or both. One or more node storage devices may be layered between and in communication with both a plurality of recognition devices and a main storage device. One or more node storage devices may function to predetermined data from a plurality of recognition devices. Each node storage device may be associated with a different set of predetermined data from the same or different recognition devices as another node storage device. The node storage devices may organize collected data into groups. For example, one node storage device may collect data for users in security settings. As another example, one node storage device may collect data associated with users in retail settings. As a further example, one node storage device may collect data for users of ages 20-29 while another collects data for users ages 30-39 (e.g., nodes assigned by age of users). As another example, one node storage device may collect data for females while another collects data for males. The one or more node storage devices may append one or more identifiers to collected data (e.g., unique identifiers), collect all data output received from a recognition device or both. The one or more node storage devices may transmit collected data to one or more main storage devices.

The system may include one or more video stream management networks. The one or more video stream management networks may function to receive and collect data from one or more personal computing devices, web servers, user interfaces, the like, or any combination thereof. The one or more video stream management networks may be at least partially hosted by the same or different physical data centers as the cloud-based network, recognition device management network, or both. The one or more video stream management networks may include one or more remote storage devices, processors, personal computing devices, web servers, or any combination thereof. The one or more video stream management networks may include one or more video stream clouds. One or more video stream clouds may include one or more memory storage devices, processors, web servers, the like, or a combination thereof. One or more video stream clouds may include video data stored therein. Video data may include one or more video streams, image data, frames, the like, or a combination thereof stored therein. One or more video stream clouds may associate one or more uniform resource locators (URL) to one or more video data files. Each video data file stored within a video stream cloud may be associated with its own URL. The one or more video stream clouds may be provided by a video streaming and hosting services within or remotely accessible to the cloud-based network, one or more personal computing devices, or both. The one or more video stream clouds may be configured to accept video streams using Real Time Streaming Protocol (RTSP), Internet Protocol (IP), the like, or a combination thereof. The video streams may be received by the video stream cloud from one or more user video clouds, user data centers, or both. A video stream cloud may be video cloud storage (e.g., remote storage) for videos of a specific user. For example, a user may have their own user authentication to log in to and save video stream files into their video stream cloud. A user data center may be a computing device of a user which is able to store video data internally.

The one or more remote storage devices may include one or more main storage devices, node storage devices, or both. One or more node storage devices may be layered between and in communication with both a plurality of recognition devices and a main storage device. One or more node storage devices may function to predetermined data from a plurality of recognition devices. Each node storage device may be associated with a different set of predetermined data from the same or different recognition devices as another node storage device. The node storage devices may organize collected data into groups. For example, one node storage device may collect data for users in security settings. As another example, one node storage device may collect data associated with users in retail settings. As a further example, one node storage device may collect data for users of ages 20-29 while another collects data for users ages 30-39 (e.g., nodes assigned by age of users). As a further example, one node storage device may collect data for users which are females while another collects data for users which are males. The one or more node storage devices may append one or more identifiers to collected data (e.g., unique identifiers), collect all data output received from a recognition device or both. The one or more node storage devices may transmit collected data to one or more main storage devices.

A cloud-based network may include one or more device and data management modules, cloud computing and data management modules, features and analytics modules, data storage modules, execution data management modules, development modules, the like, or any combination thereof.

The system may include a device and data management module. The device and data management module may function to collect, organize, and store data received from one or more recognition devices. Data may include video streams, frames, images, sound, frame analysis results, user data, recognition device data, the like, or any combination thereof. The device and data management module may include recognition device event management, recognition device management, and recognition device storage. The device data management module may be in communication, either directly and/or indirectly, with one or more recognition devices. The device data management module may be in communication with one or more remote storage devices. The device data management module collect data from one or more recognition device via recognition device management. Recognition device management may include one or more IoT gateways, connections, and the like. Recognition device management may be any hardware and/or software component suitable for receiving data from one or more recognition devices, remote storage devices, or both. The collected data is then collected and organized by recognition device event management. The recognition device event management may include one or more processors. Recognition device event management may filter and sort collected data from one or more recognition devices. Recognition device event management may sort collected data by users, timestamps, ages of users, genders of users, health events found, geolocations, the like, or any combination thereof. Recognition device management may associate data related to one or more users to one or more user records. Recognition device management may transmit collected and organized data to recognition device storage. Recognition device storage may include one or more memory storage devices. Recognition device storage may include one or more memory mediums, storage mediums, or both. Recognition device storage may include one or more databases. Recognition devices storage may provide for long-term storage, short-term storage, or both. The recognition device storage may transmit collected data to one or more data storage modules. The recognition device storage may transmit collected data to execution storage for long-term storage.

The system may include a cloud computing and data management module. The cloud computing and data management module may function to collect, organize, and store data received from one or more personal computing devices, web servers, the like, or a combination thereof. Data may include video streams, frames, images, sound, frame analysis results, user data, recognition device data, the like, or any combination thereof. The cloud computing and data management module may include a cloud computing module, cloud event management, cloud computing storage, the like, or a combination thereof. The cloud computing module may be in communication, either directly and/or indirectly, with one or more personal computing devise, web servers, the like, or a combination thereof. The cloud computing module may be in communication with one or more remote storage devices. The cloud computing and data management module may collect data from one or more personal computing devices, web servers, remote storage devices, or any combination thereof via the cloud computing module. The cloud computing module may include one or more IoT gateways, connections, and the like. The cloud computing module may include one or more network/IP/S3/RSTP gateways. The cloud computing module may be any hardware and/or software component suitable for receiving data from one or more personal computing devise, web servers, remote storage devices, or both. The collected data is then collected and organized by cloud computing. Cloud computing may include one or more processors. Cloud computing may filter and sort collected data from one or more personal computing devices, web servers, remote storage locations, or a combination thereof. Cloud computing may sort collected data by users, timestamps, ages of users, genders of users, health events found, geolocations, the like, or any combination thereof. Cloud computing may associate data related to one or more users to one or more user records. Cloud computing may transmit collected and organized data to cloud computing storage. Cloud computing storage may include one or more memory storage devices. Cloud computing storage may include one or more memory mediums, storage mediums, or both. Cloud computing storage may include one or more databases. Cloud computing storage may provide for long-term storage, short-term storage, or both. Cloud computing storage may transmit collected data to one or more data storage modules. The cloud computing storage may transmit collected data to execution storage for long-term storage.

The system may include one or more data storage modules. The one or more data storage modules may function to store received data for short-term storage, long-term storage, further analytics, the like, or a combination thereof. One or more data storage modules may include a single or a plurality of storage modules. One or more data storage modules may include execution event storage, cloud storage, execution storage, the like, or a combination thereof. One or more data storage modules may be located within a cloud-based network. One or more data storage modules may include one or more servers, memory storage devise, the like, or a combination thereof. One or more data storage module may include one or more databases stored therein. Execution event storage may provide for an organized record of all detected health events, a portion of detected health events, or both. Organized may mean in chronological sequence from most recent detected event to oldest detected event. A portion of detected health events may be over a predetermined period of time. A period of time may be a predetermined time frame from the present day and back. For example, 6 months, 1 year, 5 years, or even 10 years. Execution storage may provide for long-term storage of data received from recognition device storage, cloud computing storage, or both. Execution storage may be accessible by one or more features and analytics modules. Execution storage may collect data from one or more devices and data management modules, cloud computing and data management modules, or both. Execution storage may collect data which includes organized collections of labeled frames, labeled video sequences, extracted data in table format, extracted data in data frames format, other output data from one or more recognition devices, the like, or any combination thereof. Cloud storage may collect data for long-term storage. Cloud storage may collect data from execution storage. Execution storage may incrementally transmit data to cloud storage. Data within cloud storage may enable development improvement and model training within a development module. Cloud storage may be accessible by a development module.

The system may include one or more features and analytics modules. One or more features and analytics modules may provide for one or more user accessible features in an application, obtaining data insights from collected data of a single user or a number of users, or both. One or more features and analytics modules may include a user features and abilities module, data analytics module, execution data management module, or a combination thereof. A user features and abilities module may function to host an application accessible by one or more personal computing devices. A user features and abilities module may allow for user to see their own data (e.g., video streams), trends, detected health events, behaviors, the like, or any combination thereof. A user features and abilities module may allow for a user to see data specific to similar groups, users as a whole, users in certain demographics, and the like. User features and abilities module may access data analytics. Data analytics may execute execution data management. Execution data management may utilize machine learning, artificial intelligence, or both. Execution data management may utilize supervised and/or unsupervised learning. Execution data management may utilize one or more machine learning models. One or more machine learning models may include supervised learning models including linear regression, logistic regression, support vector machine, the like, or a combination thereof. One or more machine learning models may include unsupervised learning models including hierarchal clustering, k-means, self-organizing map, the like, or a combination thereof. One or more machine learning models may allow for effective analysis of user data, extraction of key data trends and insights, or both. Analytics may then be used by the user features and abilities module. The user features and abilities module may allow for trend predictions and data interpretation to provide a concise and comprehensive overview of one or more users' activity. User features and abilities module may provide real-time alerts, push notifications, and/or displays on user interfaces via one or more personal computing devices.

The system may include a development module. The development module may function to collect and organize data received by the system, provide continuous development improvement and model training, or both. The development module may include a development data management module, data analytics module, development testing module, model and feature development module, a synthetic training data module, the like, or a combination thereof.

The development data management module may collect and organize data for training. The development data module is in communication with one or more storage device modules. The development data module collects and organizes data from cloud storage. The organized data may be referred to as one or more training data sets. One or more training datasets may also be obtained from publicly or privately available datasets which are stored within cloud storage. The one or more training data sets may include real data, synthetic data, or both. Synthetic data can be derived from a machine learning model, such as a GAN model. The development data module enables improvement and training opportunities for current and new models. The models may be located in the model and feature development module. The development data management module may store the collected and organized data within one or more databases. The development data management module may store the collected and organized data within a development cloud training database.

The data analytics module may provide for data insights which can allow for the creation and optimization of one or more current or new machine learning models, artificial intelligence models, or both. The data analytics module may include one or more sub-modules. One or more sub-modules may include a visualization module, data analytics generation module, feature extraction module, the like, or a combination thereof. A visualization model may be what enables visualization of the data via one or more user interfaces. A data analytics generation module may provide for detailed analytics. The data analytics generation module may use data from one or more databases, such as a development cloud training database. The data analytics generation module may use machine learning models to analyze the data. The one or more machine learning models may be trained via supervised training models, unsupervised training models, or both. Supervised training models may include linear regression, logistic regression, support vector machine, the like, or any combination thereof. Unsupervised training models may include hierarchical clustering, k-means, and the self-organizing map, the like, or a combination thereof. The resulting data insights from the data analytics model may enable a feature extraction model. A feature extraction model may allow for specific features to be isolated and extracted from the resulting data. Isolated and extracted data and features may be saved within one or more databases, such as an extracted features database. The development data management module, data analytics module, or both may break down data for use of training the one or more machine learning models.

Data types to be used for training may include one or more video streams, still images, frames, sound, the like, or a combination thereof. The data types may be real data, synthetic data, or both. Video streams may be received in one or more video coding formats. One or more video coding formats may include H.264, HEVC, VP8, VP9, the like, or a combination thereof. Video frames, images, or both may be received in one or more image formats. One or more image formats may include .png, .jpeg, .gif, the like, or any combination thereof. Data information in addition to or appended to one or more video streams, still images, frames, sound, or the like (e.g., data labels) may include one or more data arrays. Data arrays may include integers, floats, decimals, pixels, NumPy values, text, the like, or a combination thereof. Data labels may be provided from data or manually labeled in a .csv, .txt, or similar file format. For video stream training and/or testing, frames may be obtained at 5 frames per second or greater, about 10 frames per second or greater, about 15 frames per second or greater, or even about 20 frames per second or greater. The video stream may be broken down to about 90 frames per second or less, about 60 frames per second or less, or even about 30 frames per second or less.

The model and feature development module may provide a method for improving and training new and current models. The new and existing models may be machine learning and/or artificial intelligence models. The development testing module may acquire and partition data from one or more databases. The one or more databases may be a development cloud training database, extracted feature database, or both. Partitioned datasets may be labeled. Labeling may be manual, automatic, or both. Labeling may include a format, type of data, associated health condition and/or health event to a record, demographic information related to users within the data, or any combination thereof. Once labeled, data may be stored within a training database. Model training may occur using the data from the training database. Model training may occur by first acquiring the data from the training database. After acquiring the data, the data may go through a preprocessing step. Preprocessing may be dependent on the type of training model. Deep learning and supervised learning algorithms, including but not limited to linear regression, logistic regression, and Support Vector Machine, are used in order to take advantage and utilize all of the potentially available data types within training database. Deep learning or deep neural networks (DNNs) are widely accepted and used by data scientists and engineers to accurately classify the different parts of video frames. DNN preprocessing may involve converting video streams to individual frames and/or acquiring frames within an extraction database. Next, the faces within the frames may be extracted, and the extractions' sizes may be standardized for input into the model. The data may be segmented into training and validation datasets with corresponding labels and then fed through a series of convolution layers with relu activation, pooling layers, and connected to a flatten layer and a fully connected (dense) layer with a SoftMax classifier. DNN model structure can change or be modified in order to improve model performance, including but not limited to adding or subtracting convolution layers, altering the input node sizes, changing the activation functions, and/or hyperparameter optimization. Supervised learning may be useful for training on text and/or numerical values. Supervised learning preprocessing involves organization of the training data into rows of input data matched with the corresponding label. Then, preprocessing may include feeding the data into one of several supervised learning models, including but not limited to linear regression, logistic regression, and Support Vector Machines. After preprocessing, the model begins to be trained. Model training may take several hours to days for deep neural networks and/or several hours for supervised learning models. Once the model is trained, the model may be evaluated by testing individual frames and/or data rows and verifying the performance. The model and feature development module may provide for a usable system with tested models. Once a sufficient model has been trained and evaluated, the model may be configured for test use, saved in a model database, or both. Poor model performance causes prediction and detection inaccuracies, which interferes with the main intention for this invention.

The development testing module may provide for rigorous testing of new and existing models. The development testing module is substantially similar to the model and feature development module. The development testing module includes partitioning one or more training datasets, labeling data, storing data within a testing database, acquiring the data from the testing database, data preprocessing, training the model, evaluating the results, the like, or a combination thereof.

The synthetic training data module may provide for quickly generating data into one or more training databases. The synthetic training model may be similar to, overlap with, and/or be part of the development testing module, the model and feature development module, or both. The synthetic training data module may incorporate one or more machine learning models. The one or more machine learning models may include one or more generative adversarial networks. The synthetic training data module may receive real data of features (e.g. facial, body) and health conditions and output statistically similar synthetic data of features and health conditions. The synthetic training data module may allow for execution of the VBR training data method.

The system may include one or more modules. The one or more modules may refer to hardware, software, or both. Modules may be physical components within the system. Modules may be processes executable by one or more processors and stored within one or more memory storage devices.

The present teachings incorporate a visual biometric recognition system, such as from PCT Application No. PCT/US2024/032781, filed on Jun. 6, 2024, incorporated herein by reference in its entirety.

### Training Biometric Recognition Model

The present teachings relate to a method of training a biometric recognition model (e.g., method of training, training method). The method of training may function to train the biometric recognition learning model. The method of training may include: collecting real image data, conducting a feature extraction process, inputting the encoded data into a learning model, generating a plurality of synthetic data samples, storing the synthetic data samples, executing one or more biometric learning models, and/or generating one or more biometric identification models.

The method of training the biometric learning model may be advantageous in more quickly building a greater database of stored facial and/or body data models.

The method of training may include collecting real image data capturing one or more individual humans. Collecting real image data may include receiving real data. Receiving real data may include collecting real video or image data including a plurality of images capturing one or more individual humans. Receiving real data may include video or image acquisition (e.g., video data collection). Reference to image acquisition may involve similar processes as video but using a single or plurality of images that may not be part of a video stream. Video acquisition may function to collect one or more outputs of one or more sensing devices. Video acquisition may function to collect one or more outputs of one or more cameras. Video acquisition may function to collect one or more images, videos, frames, sounds, the like, or any combination thereof. Video acquisition may use computer vision. Video acquisition may function to store one or more incoming video streams for further analysis. Video acquisition may be automatically executed by a recognition device, image processing unit, cloud computing module, cloud computing and data management module, the like, a combination thereof. Video acquisition may be automatically executed by one or more processors of an image processing unit, cloud computing module, or both. Video acquisition may be automatically executed upon a camera stream input being detected, one or more video streams being received by an image processing unit or cloud computing module, or combination thereof. Commencement of video acquisition may trigger a recording service. A recording service may be a process for recording the incoming video stream. A recording service may be a process which includes transferring and storing the incoming video stream within the recognition device, image processing unit, storage medium, remote storage device, cloud network, a device and data management module, the like, or any combination thereof. The incoming video stream may be received from the camera by the image processing unit and transmitted for storage in the storage medium of the image processing unit. The incoming video stream may be received from the camera by the image processing unit and transmitted for storage in a remote storage device, a device and data management module, or both. The incoming video stream may be transmitted for storage by the image processing unit toward the storage medium, remote storage device, and/or the device and data management module in any sequence, simultaneously, or a combination thereof. The image processing unit may associate the incoming video stream with one or more identifiers prior to storage. The one or more identifiers may include one or more users, recognition devices, timestamps, geolocations, known health condition being experienced, the like, or any combination thereof. After video acquisition, the VBR training data method may move on to preprocessing or be free of preprocessing. Collecting the video data may be automatic, manually generated, or both. Automatic may occur as described relative to the VBRM method.

The method of training may include preprocessing. Preprocessing may function to break down the incoming video stream into a format which can be further analyzed by the image processing unit. Preprocessing may access an incoming video stream from one or more storage mediums, remote storage devices, device and data management modules, the like, or a combination thereof. Preprocessing may be automatically executed by the one or more processors of the image processing unit, cloud computing module, cloud computing and data management module, the like, or a combination thereof. Preprocessing may be automatic upon receipt of the video data. Preprocessing may function to break down the incoming video stream into one or more frames. The video stream may be broken down to a frame rate about equal to or less than a frame rate captured by the camera. The video stream may be broken down to about 5 frames per second or greater, about 10 frames per second or greater, about 15 frames per second or greater, or even about 20 frames per second or greater. The video stream may be broken down to about 90 frames per second or less, about 60 frames per second or less, or even about 30 frames per second or less. The one or more frames may be used by one or more subsequent steps and/or sub-steps of the VBR training data method. Preprocessing may include initiating model identification, environmental analysis, or both.

The method of training may include automatically conducting a feature extraction process on the real image data, wherein the feature extraction process includes: i) feature detection for detecting one or more facial features, body features, or both in the plurality of images; ii) feature extraction for extracting the one or more facial features, body features, or both which are detected from the plurality of images; and iii) feature encoding for converting the one or more facial features, body features, or both which are extracted into one or more arrays forming the encoded data.

The method of training may include executing a feature extraction process. The feature extraction process may function to detect one or more features from the real data, extract one or more features from the real data, encode the one or more features from the real data, or any combination thereof. One or more features may include one or more faces, body parts, environment, pose, behavior, and/or the like. Feature extraction may be completed by an image processing unit of the recognition device, cloud computing module, cloud computing and data management module, the like, or a combination thereof. The feature extraction process may be automatically executed by the one or more processors of the image processing unit, cloud computing module, cloud computing and data management module, the like, or a combination thereof. The feature extraction process may be automatic upon receipt of the video data, preprocessed video data, or both. Feature extraction may include feature detection, feature extraction, feature encoding, or a combination thereof.

The feature extraction process may include feature detection. Feature detection may function to find one or more features within one or more frames. Feature detection may include boxing, bounding, or otherwise marking the one or more features.

The feature extraction process may include feature extraction. Feature extraction may extract the detected features from the frames. Feature extraction may include breaking down the resolution of the feature(s). Feature extraction may include cropping the one or more frames upon detection of the one or more features. Face extraction may crop a frame such that the image is focused on one or more specific features, cropped to a predetermined resolution, cropped to a predetermined shape, the like, or any combination thereof. Cropping may involve cropping the frame such that the image is focused on the feature, the background is removed, or both. Cropping may involve cropping the image to a standard shape. A standard shape may be rectangular, square, circular, ovular, the like, or any combination thereof. Cropping may involve cropping the image to a predetermined resolution. An image may be cropped to a resolution equal to or less than capable of capturing by a sensing device (e.g., camera). An image may be cropped to be about 150 pixels or greater, about 200 pixels or greater, or even about 300 pixels or greater in one or more directions (e.g., height and/or width). An image may be cropped to be about 1080 pixels or less, about 720 pixels or less, or even about 640 pixels or less in one or more directions (e.g., height and/or width). Cropping may allow for one or more frames to be evaluated with a consistent size and resolution. Feature extraction may include converting the video data to relevant numeric data in a time series format. The data after feature extraction may be referred to as extracted feature data.

The feature extraction process may include feature encoding. Feature encoding may allow for the extracted features to be converted into data which can allow for future use and playback, collection of mathematical data (e.g., relationships) between different features, improve data quality, and/or the like. Feature encoding may function to classify the status of one or more features of a face, body, or both from one or more frames. Feature encoding may be applied to extracted feature data. Feature encoding may include converting one or more extracted features (e.g., faces, body parts (e.g., full or partial body)), or both from one or more frames into one or more pixel arrays. The one or more pixel arrays may represent one or more orthogonal components of feature encoding. Feature encoding may include finding one or more mathematical points and/or relationships in facial features, body features, or both. Feature encoding may convert the video data to relevant numeric data in a timeseries format. The one or more pixel arrays may be used by one or more models. Feature encoding may include smoothening out and standardizing the data. Smoothening and standardizing may function to reduce graininess and increase the quality of the data. Upon completion of the feature encoding, the converted data may be referred to as encoded data. The encoded data may be useful for utilizing within one or more machine learning frameworks or models to generate synthesized data.

The method of training may include executing one or more machine learning methods for generating synthesized data. The one or more machine learning methods may include one or more data augmentation models. The one or more data augmentation models may include a generative adversarial network (“GAN”) model. The one or more machine learning methods may function to generate synthesized data resembling the real data, such as to train one or more other machine learning models. The machine learning method may function to provide synthetic data for use in a model testing and training method. The machine learning method, such as the GAN model, may be particularly useful in not only generating the synthetic data, but the data having the same statistics as the training set (e.g., incoming real data). This synthetic data allows for unsupervised learning, semi-supervised learning, fully supervised learning, and/or reinforcement learning. This synthetic data allows a model testing and training method to take significantly less time and collection of real data while generating similar learnings and accuracy. The machine learning model may be executed by an image processing unit of the recognition device, cloud computing module, cloud computing and data management module, the like, or a combination thereof. The machine learning model may be automatically executed by the one or more processors of the image processing unit, cloud computing module, cloud computing and data management module, the like, or a combination thereof. The machine learning model may be automatic upon receipt of the video data, preprocessed video data, feature data, extracted data, encoded data, or any combination thereof.

The machine learning model may include a core model. The core model may function as the starting model. The core model includes latent code(s). The core model functions to receive both real data and random noise. The core model may specifically be a generative adversarial network core model.

Executing the machine learning model may include the core model receiving the real data. The real data may be fed into the model as the real data, the extracted data, and/or the encoded data. The encoded data may provide the most efficient and useful data form for use by the core model.

Executing the machine learning model may include the core model receiving random noise. Random noise may be introduced into the core model such that the synthetic data is as close to mimicking real data as possible. Random noise may refer to random or unpredictable fluctuations in data which may disrupt the ability to easily identify target patterns or relationships. The random noise is intended to mimic incorrect data collection, poor image quality, and the like. The random noise may be introduced as missing data values, outliers, wrong and/or inconsistent data formats.

Executing the machine learning model includes the core model minimizing types of loss. Loss may be defined as the discrepancy between incoming real data and the outgoing synthesized data. Loss may include supervised loss, unsupervised loss, reconstruction loss, or a combination thereof. Reducing supervised loss helps the core model learn the relationship among facial and/or body feature variables that are generated by the machine learning model. For minimizing supervised loss, the model is provided with the necessary conditions to ensure the model understands the positional relationships among the facial and/or body features. In other words, the conditions include how one facial or body feature point can move relative to another. Reducing unsupervised loss helps the machine learning model to the distribution of the sequence of real data that is fed into the model. Minimizing reconstruction loss allows for accurate reconstruction via reversible mapping. The reversible mapping may be between facial and/or body features and latent spaces. Minimizing of the reconstruction loss aids in the model having a good latent embedding space.

The method of training may include executing a sampling process. A sampling process may function to generate samples and check the performance quality of the machine learning model. A sampling process may include the machine learning model (e.g., GAN model) outputting a number of samples. The samples may be in the form of synthetic data statistically similar to the real data. The samples may take the form of the pixel arrays of one or more features (e.g., face, body, etc.). The samples may also depict one or more health conditions being experienced (e.g., an individual yawning, being distracted, experiencing a seizure). The sampling process may generate 100 to 10,000 or even more samples. The sampling process may include a quality check. The quality check may check the samples for correctness of the samples, statistical differences to the real data, and/or the like. The quality check may look for the generated samples to be accurate by about 75% or greater, about 80% or greater, or even 85% or greater. The quality check may look for the generated samples to be accurate by about 100% or less, about 99% or less, or even about 97% or less. For example, the quality check may look for the samples to be about 80% to about 97% accurate. The samples which meet the quality check criteria may be outputted as final synthetic data. Once the model is consistently at the desired accuracy, the samples may continuously be stored as final synthetic data. After the quality check, some or all of the samples may be resampled. By resampling, the samples may be fed back into the machine learning model. This resampling allows for the synthetic database to grow an exponentially quicker pace. The sampling process may be executed by an image processing unit of the recognition device, cloud computing module, cloud computing and data management module, the like, or a combination thereof. The sampling process may be automatically executed by the one or more processors of the image processing unit, cloud computing module, cloud computing and data management module, the like, or a combination thereof. The sampling process may be automatic upon receipt of synthetic data from a machine learning model.

The method of training may include storing the plurality of synthetic data samples. Storing may include storing in one or more storage mediums. Storing the synthetic data may include automatically storing the synthetic data within one or more databases. The plurality of synthetic data samples may be stored in one or more synthetic facial databases. The synthetic facial databases may be accessible via one or more networks (e.g., internet). Storing synthetic data allows for its future retrieval for use with other models and training method. One or more databases may include a testing database or similar. Storing may be executed by an image processing unit of the recognition device, cloud computing module, cloud computing and data management module, the like, or a combination thereof. Storing may be automatically executed by the one or more processors of the image processing unit, cloud computing module, cloud computing and data management module, the like, or a combination thereof. Storing may be automatic upon receipt of synthetic data from a machine learning model, upon receipt of synthetic data which passes the quality check in a sampling process, or both.

The method of training may include executing one or more biometric learning models. The one or more biometric learning models may function to pretrain models using machine learning, deep learning, and/or other artificial intelligence models. The one or more biometric learning models may function to train one or more biometric identification models, object identification models, or both. The one or more biometric learning models may train one or more biometric identification models to recognize a plurality of biometric marks within an individual's face, body, or both. The one or more biometric learning models may train one or more object identification models to recognize a plurality of objects typically associated with human individuals. Objects may include glasses, eye patches, scars, wrinkles, moles, jewelry, makeup, hair accessories, and/or the like. The one or more biometric learning models may be stored on one or more storage mediums, accessible and executable by one or more processors, or both.

The method of training may include generating one or more biometric identification models. The one or more biometric identification models may be generated from executing the one or more biometric learning models. The one or more biometric identification models may be stored in one or more storage mediums. The one or more biometric identification models may be accessible across a network.

One or more or all of the steps of the method of training may be executed by one or more processors. The one or more processors complete one or more or each step automatically upon execution of an earlier step. The one or more processors may access the instructions for each step from a storage medium. One or more artificial intelligence processors may be configured for executing this method.

The present teachings incorporate the visual biometric recognition training data method and/or visual biometric recognition and monitoring method as disclosed in PCT Application No. PCT/US2024/032781, filed on Jun. 6, 2024, incorporated herein by reference in its entirety.

### Registering User into Biometric Recognition System

The method may include registering one or more users into the system. By registering, a user's biometric information may be collected, a unique identifier may be generated, a payment method may be associated with the user, an authenticator may be associated with a unique identifier or user, trends may be associated with the user, the like, or a combination thereof.

Registering may include capturing one or more images of a user. One or more images may be one or more images of a face, body, or both of the user. One or more images may include one or more varying angles and/or poses of a face, body, or both. The images may be captured as video, static images, frames, the like, or a combination thereof. The images may be captured by one or more cameras. One or more cameras may be one or more designated cameras. One or more cameras may include one or more cameras executed by an application on a mobile device, camera(s) at predetermined venue, camera at a setting, or a combination thereof. A predetermined venue may include any setting participating in user registration, such as a commercial setting. Predetermined venues may include any venue participating in registering the users, such as a retail store, bank, post office, and/or the like. Registering may also include or be free of capturing user data, such as name, birthday, age, gender, driver's license number, social security number, mailing and/or residential address, citizenship, the like, or any combination thereof. Registering may include a user profile being created in one or more user profile databases. The user profile may store the user data, images, biometrics, unique identifier, the like, or any combination thereof.

Registering may include extracting one or more biometrics from the images of the user. The one or more biometrics may be facial biometrics, body biometrics, or both. The one or more biometrics have feature detection, feature extraction, and/or feature encoding executed thereon. These processes may be similar or same as discussed herein with respect to the method of training but applied to the image(s) of the user. The one or more user biometrics may be converted into one or more arrays and/or vectors. The one or more biometrics may be the same biometrics used or found as useful by a method of training or method of biometric recognition.

Registering may include matching a user's biometrics with biometrics from the one or more synthetic facial database. Each biometric data point extracted from a user may be correlated to a synthetic biometric data point. The synthetic biometric data point may be stored and accessed from one or more synthetic databases (e.g., synthetic facial databases). This synthetic biometric data point may then be stored relative to a user's profile and/or unique identifier.

Registering may include creating a unique identifier (Unique ID). The unique identifier may function as a visual identifier to identify an individual. The unique identifier may be comprised by a plurality of synthetic biometric data points. The synthetic biometric data points may be those corrected to each extracted biometric data point extracted from the user. The unique identifier may be stored within one or more user identifier databases, user and/or user profile databases, or both. The database may include the unique identifier, one or more initial images of a user, other user data, or any combination thereof.

Registering may include associating a unique identifier with one or more payment methods. A user when creating their profile may associate their unique identifier with one or more payment methods of their preference. One or more payment methods may include one or more credit cards, debit cards, bank accounts, wire accounts, the like, or a combination thereof. It is also possible the unique identifier may be associated with one or more other alternate payment systems. Alternate payment systems may include Square, Paypal, Apple Pay, the like, or any combination thereof. A user may capture an image of a payment method, the method may automatically recognize and capture the payment information from the image, or both. The user may type in their one or more payment methods. One or more payment methods may be stored in one or more user profile databases, identifier databases, payment databases, or a combination thereof. If stored in a separate database as the profile and/or unique identifier, one or more payment databases may associate or otherwise correlate one or more payment methods with the one or more designated users.

Registering may include associating a unique identifier with another authenticator. The authenticator may function to provide another layer of security in addition to visual recognition. The authenticator may be a personal identification number (PIN), password, code, phone number, the like, or a combination thereof. An authenticator may even be a code generated from an authenticator application. The authenticator may be at least partially stored and/or associated with in an authentication database, correlated or otherwise associated with a unique identifier, user profile, and/or payment method.

One or more or all of the steps of the method of registration may be executed by one or more processors upon initiation by the user. The one or more processors complete one or more or each step automatically upon execution of an earlier step. The one or more processors may access the instructions for each step from a storage medium. One or more artificial intelligence processors may be configured for executing this method.

### Facial Recognition and Automatic Payment Execution

The method may include executing automatic payment upon recognizing a user and their unique identifier.

The method may include capturing one or more images of a user. The one or more images may include one or more videos, static images, frames, the like, or a combination thereof. The one or more images may be captured by one or more vision capture systems. One or more vision capture systems may include one or more cameras, infrared, sonar, lidar, the like, or a combination thereof. One or more vision capture systems may be implemented within a setting. One or more vision capture systems may be located at an entrance, exit, counter, shelf, gate, the like, or any combination thereof. Capturing may be initiated by a user, automatic upon detecting a user, or both. The vision capture system may be or include a recognition device as disclosed hereinbefore. The vision capture system may be or include a computing device which includes or acts as a portal with a user interface.

The method may include extracting one or more biometrics from the images of the user. The one or more biometrics may be facial biometrics, body biometrics, or both. The one or more biometrics have feature detection, feature extraction, and/or feature encoding executed thereon. The extracted biometrics may be the same biometrics found useful for creation of a unique identifier. The one or more user biometrics may be converted into one or more arrays and/or vectors.

The method may include identifying the user by matching the user biometrics to a unique identifier. The method may include searching and filtering one or more registered user databases. The method may include substantially matching a user record based on one or more matching user biometrics. The method may include identifying a user based on the unique identifier.

The method may be free of using prior documentation and/or prior knowledge device authorization to provide any identification data contributing toward identifying the user.

The method may include authenticating a user with an authenticator. Authentication may occur after the identifying. Authentication may include a user entering the authenticator into a portal of the system.

The method may include executing automatic payment from one or more payment methods associated with the user. The user may scan one or more items and/or the item may be automatically detected by one or more sensing systems. A total price may be automatically generated. One or more payment methods associated with the user may then be automatically initiated for payment of the one or more items. The payment may be completed without the user need to manually use their payment method (e.g., grab credit or debit card from wallet or purse) or to even initiate a tap-to-pay method (e.g., grabbing mobile phone and initiating tap-to-pay method).

The method may include generating one or more personalized recommendations. One or more personalized recommendations may include tailored shopping recommendations based on the shopping habits of an individual. Shopping habits may include historical shopping trends, search history in third party search platforms, discounts on similar products, inputs received from one or more household applications, the like, or a combination thereof. The one or more personalized recommendations may be displayed on the portal.

This recognition may be as disclosed hereinbefore and/or as in PCT Application No. PCT/US2024/032781, filed on Jun. 6, 2024, incorporated herein by reference in its entirety.

### Working Examples

### Working Example A: Just Walk Out Use Case

Recent tests with in-store cameras detect products picked up by customers and charge them automatically, eliminating the need for scanning. With the payment method of the present disclosure:
Step 1. Upon Store Entry: A camera part of a visual recognition device captures one or more images (e.g., video stream) of the customer walking in. The visual recognition device executes or initiates execution or a facial recognition and automatic payment execution method. The customer's identification is generated by finding their unique identifier based on the visual recognition. Payment information and loyalty/rewards associated with the unique identifier may be automatically linked to the customer.
Step 2. Customized Shopping List: Generative AI and a recommendation engine provide a shopping list and product suggestions based on past purchases and browsing history. This information can be displayed on the customer's phone or a retailer's smart shopping cart (e.g., via an application).
Step 3. Enhanced Security and Insights: The system improves security monitoring and provides insights based on the behavioral model, focusing on individual behavior rather than race or gender.
Step 4. Smart Shopping Cart: A shopping cart equipped with a display or screen for enhanced shopping convenience. The display may show all items put into the shopping cart.
Step 5. Automatic Checkout: The shopping cart may pass a part of vision capture system when the customer is departing the store. Whether via the display or screen of the shopping cart or sensing devices on each item in the cart, the system recognizes a total price of all items collected by the customer. An automatic payment system associated with the unique identifier of the customer may be automatically charged for the items.

### Working Example B: Digital Consumption Use Case

Step 1. Using the camera inside the digital device (phone, tablet, tv) to map users biometrics to allow verification for digital media consumption and advertising.

### Illustrative Examples

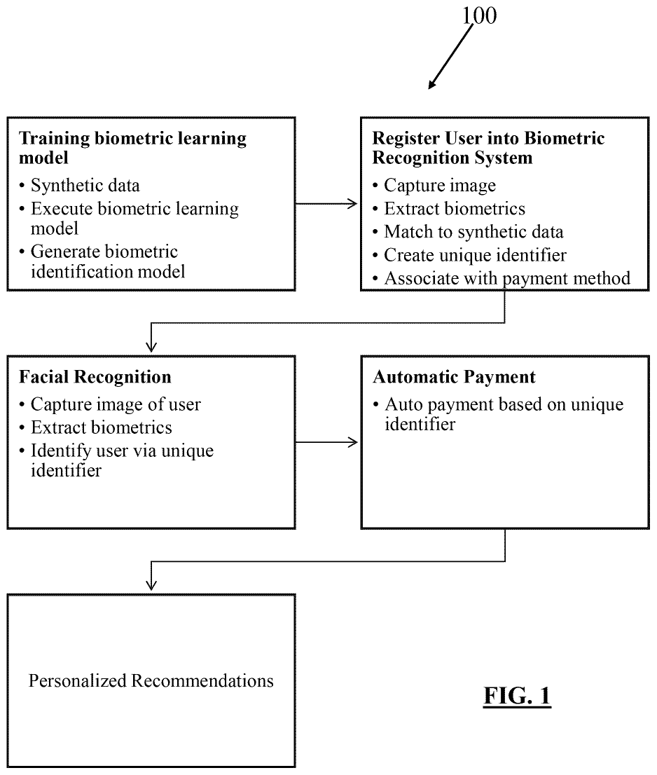

FIG. 1 illustrates a flow chart of the visual biometric recognition system and method for training, registration, recognition, and automatic payment 100. The method may be completed by one or more processors of the system. Different processors may complete different steps or a single processor may complete the different steps of the method. Some of the method may be completed locally (on site at setting) while part of the method may be completed remotely (e.g., cloud), or all locally on site.

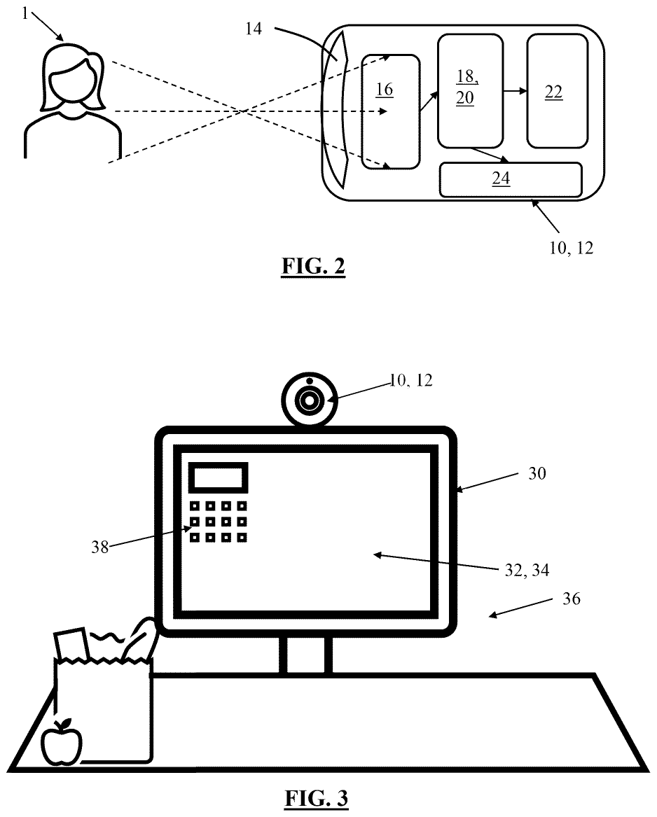

FIG. 2 illustrates a visual recognition device 10 and architecture thereof. The visual recognition device 10 may be any device suitable for capturing one or more images of the face and/or body of a user 1. The visual recognition device 10 may include or be a camera 12. The camera 12 is able to capture video and/or images of a user 1. The images and/or video stream are captured by a lens 14. The images pass the lens 14 are captured by an image sensor 16. The image sensor 16 is in communication with a processor 18. The processor 18 may be an image processor 20. The image sensor 16 and/or processor 18 are in communication with a storage medium 22. The visual recognition device 10 may also include a communication module 24. The visual recognition device 10 may be integrated into another computing device or be standalone. The visual recognition device 10 may be executed on a personal computing device such as a mobile phone. The visual recognition device 10 may be part of a kiosk with a portal within a setting having the device and a user interface.

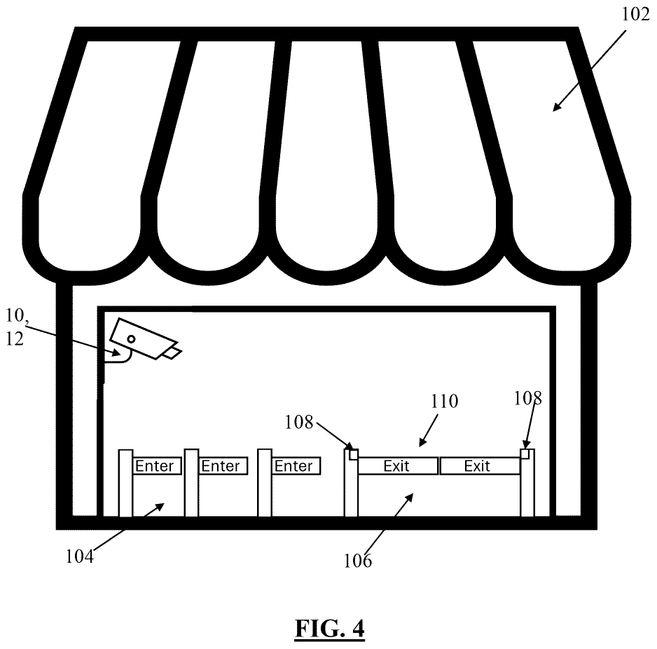

FIG. 3 illustrates a visual recognition device 10, including a camera 12. The facial recognition device 10 is part of a kiosk 30 with a portal 32. For example, a kiosk 30 integrated at a check-out counter 36 at a retail setting. The portal 32 may be a user interface 34, such as one with a touch screen. The kiosk 30 may generate an authenticator input 38 on the user interface 34. The authenticator input 38 may be generated after identification of the user via associating their image to a substantially matching unique identifier.

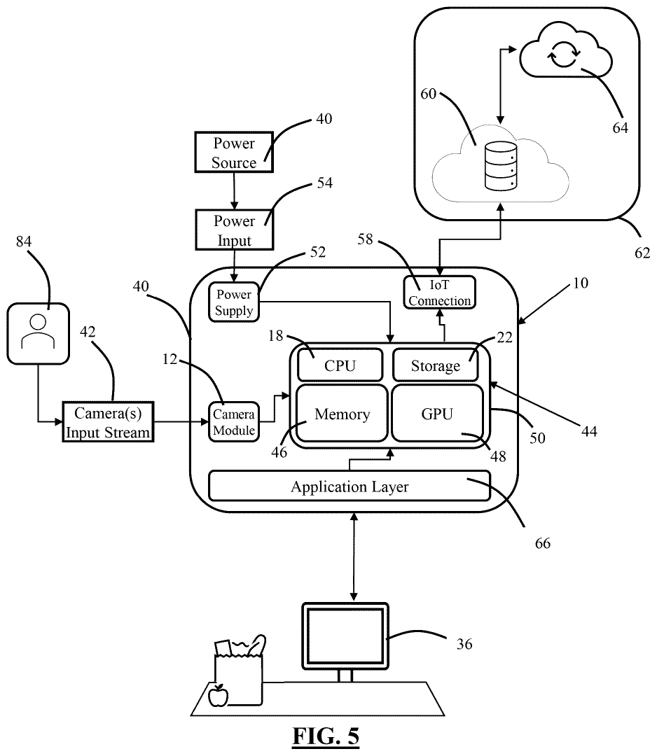

FIG. 4 illustrates using a visual recognition device 10, including a camera 12, at a retail setting 102 at the entrance and exit 104. The recognition device 10, 12 may be integrated at an entry/exit 104 of a retail store 102 such as to automatically recognize and identify a user entering and/or leaving. The recognition device may cooperate with automatic product checkout systems 106 (e.g., identifying products in a user's cart or bags via scanners or other transmitters and product tags or other visuals). The automatic product checkout systems 106 may be integrated at the entry/exit 104 of the retail store. For example, one or more sensing systems 108 may be integrated into or near an exit gate 110.

FIG. 5 illustrates a recognition device 10. The recognition device 10 includes a housing 40. The recognition device 10 includes a camera (e.g., camera module) 12. As an alternative, the camera 12 may be outside of and separate from the housing 22. The camera 12 receives a camera input stream 42. The camera input stream 42 occurs when a user 1 is in view of the camera 12. The camera module 12 is connected to and in communication with an image processing unit 44. The recognition device 10 includes a processor 18, storage medium 28, memory medium 46, and graphics unit processor 48. The image processing unit 34 may include a circuit (e.g., circuit board) 50. The circuit 50 supports and connects the processor 18, memory medium 46, storage medium 22, and graphics unit processor 32. The image processing unit 44 is in electrical communication with a power supply 52. The power supply 52 is connected to a power input 54. The power input 54 is connected to a power source 56. The recognition device 10 includes a network connection 58. The network connection 58 may be an IoT connection. The network connection 58 allows for the recognition device 10 to be in communication with a remote storage device 60. The remote storage device 60 is in communication with and part of a network 62. The network 62 also includes a cloud-based network 64. The recognition device 10 includes an application layer 66. The application layer 46 may be part of or accessible by the image processing unit 44. The application layer 46 may include one or more facial recognition and monitoring instructions stored therein which are accessible for execution by the image processing unit 44. The recognition device 10 is connected may be connected to part of a retail store, such as a kiosk 30 or other system.

Any numerical values recited in the above application include all values from the lower value to the upper value in increments of one unit provided that there is a separation of at least 2 units between any lower value and any higher value. These are only examples of what is specifically intended and all possible combinations of numerical values between the lowest value, and the highest value enumerated are to be considered to be expressly stated in this application in a similar manner. Unless otherwise stated, all ranges include both endpoints and all numbers between the endpoints.

The term “consisting essentially of” to describe a combination shall include the elements, ingredients, components, or steps identified, and such other elements ingredients, components or steps that do not materially affect the basic and novel characteristics of the combination. The use of the terms “comprising” or “including” to describe combinations of elements, ingredients, components, or steps herein also contemplates embodiments that consist essentially of the elements, ingredients, components, or steps.

Plural elements, ingredients, components, or steps can be provided by a single integrated element, ingredient, component, or step. Alternatively, a single integrated element, ingredient, component, or step might be divided into separate plural elements, ingredients, components, or steps. The disclosure of “a” or “one” to describe an element, ingredient, component, or step is not intended to foreclose additional elements, ingredients, components, or steps.

What is claimed is:

1. A method for identifying a user based on facial recognition and synthetic facial data, the method including:
a) executing visual biometric recognition training by one or more processors which generates a plurality of synthetic data samples;
b) executing one or more biometric learning models by the one or more processors on the synthetic data samples to create one or more biometric identification models;
c) registering one or more users into a biometric recognition database and the one or more processors associating biometric data of a user with biometric data from the synthetic data samples;
d) the one or more processors automatically creating a unique identifier associated with each user based on the biometric data and the synthetic data;
e) the one or more processors automatically identifying the user based on extracting one or more biometrics from the images of the user and matching the biometrics with the unique identifier.

2. The method of claim 1, wherein the executing the visual biometric recognition training includes collecting real image data capturing one or more individual humans; and
wherein the executing the visual biometric recognition training includes automatically conducting a feature extraction process on the real image data; and
wherein the feature extraction process includes feature detection, feature extraction, and feature encoding.

3. The method of claim 2, wherein the feature extraction process includes inputting the encoded data into a learning model; and
wherein the method includes generating the plurality of synthetic data samples from the learning model.

4. The method of claim 3, wherein the plurality of synthetic data samples are in the form of one or more arrays and/or vectors.

5. The method of claim 1, wherein the plurality of synthetic data samples are stored in one or more synthetic facial databases in one or more non-transitory storage mediums.

6. The method of claim 1, wherein the executing of one or more biometric learning models trains and generates one or more biometric identification models; and
wherein the biometric identification model recognizes a plurality of biometric marks within an individual's face, body, or both.

7. The method of claim 6, wherein the executing of the one or more biometric learning models trains and generates one or more object identification models.

8. The method of claim 6, wherein the one or more biometric identification models are stored in one or more non-transitory storage mediums.

9. The method of claim 1, wherein the registering the one or more users includes capturing one or more images of a user and automatically extracting one or more biometrics from the one or more images of the user.

10. The method of claim 9, wherein the one or more biometrics related to the user are matched with one or more synthetic biometrics from a synthetic database.

11. The method of claim 10, wherein the registering includes creating and associating a unique identifier with the user.

12. The method of claim 11, wherein the unique identifier is based on the one or more synthetic biometrics matched to the user's biometrics.

13. The method of claim 12, wherein the unique identifier is in the form of an array and/or vector.

14. The method of claim 1, wherein the unique identifier of the user is associated with one or more payment methods.

15. The method of claim 1, wherein the unique identifier is associated with one or more authenticators.

16. The method of claim 1, wherein the identifying the user includes capturing one or more images of the user and extracting one or more biometrics from the images of the user; and
wherein the identifying includes the one or more biometrics being converted into one or more arrays and/or vectors; and
wherein the one or more arrays and/or vectors associated with the one or more biometrics are matched to one or more arrays and/or vectors of a unique identifiers to identify the user.

17. The method of claim 1, wherein the identifying the user is free of referencing a prior documentation and/or prior knowledge device.

18. The method of any of the preceding claims, wherein the identifying includes authenticating a user with an authenticator after identifying based on the one or more biometrics.

19. The method of claim 1, wherein after the identifying, the method includes executing an automatic payment; and
wherein the automatic payment includes automatically causing payment from one or more payment methods associated with the user and/or unique identifier to transfer funds to a setting in which the system is located, an intended payee, or both.

20. A method for identifying a user based on facial recognition and synthetic facial data, the method including:
a) executing visual biometric recognition training by one or more processors which generates a plurality of synthetic data samples;
wherein the executing the visual biometric recognition training includes collecting real image data capturing one or more individual humans; and
wherein the executing the visual biometric recognition training includes automatically conducting a feature extraction process on the real image data; and
wherein the feature extraction process includes feature detection, feature extraction, and feature encoding;
wherein the feature extraction process includes inputting encoded data from the feature encoding into a learning model and generating the plurality of synthetic data samples from the learning model which are in the form of one or more arrays and/or vectors and storing within one or more synthetic databases;
b) executing one or more biometric learning models by the one or more processors on the synthetic data samples to create one or more biometric identification models;
wherein the executing of the one or more biometric learning models trains and generates one or more biometric identification models and wherein the one or more biometric identification models recognize a plurality of biometric marks within an individual's face, body, or both;
c) registering one or more users into a biometric recognition database and the one or more processors associating biometric data of a user with biometric data from the synthetic data samples;
wherein the registering the one or more users includes capturing one or more images of a user and automatically extracting the one or more biometrics from the one or more images of the user as identified by the one or more biometric identification models;
wherein the one or more biometrics related to the use are matched with one or more synthetic biometrics from the one or more synthetic databases;
d) the one or more processors automatically creating a unique identifier associated with each user based on the biometric data and the synthetic data;
wherein the one or more synthetic biometrics which match the biometrics of the user are then used to create a unique identifier and associate the unique identifier with the user and the unique identifier is in the form of an array and/or vector;
wherein the user also associates one or more payment methods with their respective unique identifier;
e) the one or more processors automatically identifying the user based on extracting one or more biometrics from the images of the user and matching the biometrics with the unique identifier; and
wherein the identifying the user includes capturing one or more images of the user and extracting one or more biometrics from the images of the user; and
wherein the identifying includes the one or more biometrics being converted into one or more arrays and/or vectors; and
wherein the one or more arrays and/or vectors associated with the one or more biometrics are matched to one or more arrays and/or vectors of a unique identifiers to identify the user; and
f) automatically executing an automatic payment by automatically causing payment from the one or more payment methods associated with the user and/or the unique identifier to transfer funds to a setting in which a system executing at least part of the method is located, an intended payee, or both.
